(19) United States
(12) Patent Application Publication
(10) Pub. No.: US 2009/0180621 A1
(43) Pub. Date: Jul. 16, 2009

(54) ADAPTIVE SECURE AUTHENTICATED CHANNELS FOR DIRECT SHARING OF PROTECTED CONTENT BETWEEN DEVICES

(75) Inventors: DAVID KRATZ, FAIRFAX, VA (US); HOSAME ABU-AMARA, ROUND LAKE, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/763,216

(22) Filed: Jan. 11, 2008

(51) Int. Cl. H04L 9/00

(52) U.S. Cl. 380/278

(57) ABSTRACT

A method for a communication device for establishing a secure authenticated channel using multiple shared keys traded with another device is described. A first shared key common to a home domain is received from a non-device entity, such as a domain manager or a trusted third party. Also, a second shared key is established with the other device. An initial integrity protection of communication relating to rights sharing between the communication device and the other device is then created using the second shared key. The integrity protection of communication relating to rights sharing between the communication device and the other device is thereafter augmented using the first shared key.

### FIELD OF THE INVENTION

The present invention relates generally to the field of systems and methods for allowing devices to directly share protected content with each other. More particularly, the present invention relates to a system and method for providing adaptive secure authenticated channels for direct sharing of Digital Rights Management (DRM) protected content between devices.

### BACKGROUND OF THE INVENTION

With the proliferation of DRM systems, it is expected that users would want to share their DRM protected content with other users. Sharing may occur on a temporary basis, such as a situation where a user wishes to allow a guest to listen to music stored on the user's entertainment center via the guest's device. In such case, when the guest leaves the user's home, the guest will no longer has access to the music on the user's entertainment center. In another scenario, the user may wish to share on a temporary basis the content with a guest device that is geographically remote from the home device. In this alternative scenario, the sharing is temporary not in the geographical sense but in the sense that the guest device can consume the content for a limited time period. The sharing may also occur on a permanent basis, such as a situation where a user wants to copy or move media content, such as a song or a movie, among devices belonging to the user. The user can access the moved or copied content on the destination device. Other scenarios are also possible, for example a hybrid scenario where a guest device can obtain initial access to content only when the guest device is within the same home as the home device, and the guest device can continue to have access to content for a limited period of time even if the guest device moves away from the home device.

Generally, current DRM systems do not have mechanisms to enable sharing on a temporary basis. To enable sharing on a permanent basis, some DRM systems use awkward mechanisms that rely on network-centric domains, where a user a priori has to notify one or more entities in an operator's network about the devices that belong in the domain. Once the domains are setup, then the devices may share content on a permanent basis.

To alleviate the awkwardness of creating network-centric domains, other DRM systems defined a mechanism for devices to use secure removable media, such as Secure Digital (SD) cards, as means to copy or move content between devices on a permanent basis. The idea is to move or copy content from a source device to a secure removable media (SRM) and, then, copy or move the content from the SRM to a destination device. A particular form of a Secure Authenticated Channel (SAC) enables security for the copied or moved content between the device and the SRM.

Accordingly, there is a need for a process that defines a mechanism to enable direct sharing between devices without the need for an intermediate entity, such as an SRM. This need exists for sharing on a temporary basis as well as sharing on a permanent basis.

### BRIEF DESCRIPTION OF THE DRAWINGS

FIG. 1 is a conceptual diagram illustrating an embodiment in which devices may directly share content in accordance with the present invention.

FIG. 2 is a conceptual diagram illustrating an embodiment in which devices belonging to a particular network may share content in accordance with the present invention.

FIG. 3 is a conceptual diagram illustrating an embodiment in which content may be shared, on a limited basis, with a device that does not belong to a particular network in accordance with the present invention.

FIG. 4 is a system diagram illustrating various features utilizing a secure authenticated channel (SAC) in accordance with the present invention.

FIG. 5 is a flow diagram illustrating an example process in which devices may directly share content in accordance with the present invention.

FIG. 6 is a flow diagram illustrating an example sub-process for the portion of FIG. 5 that identifies a home device and/or guest device in accordance with the present.

FIGS. 7 through 10 are flow diagrams illustrating example sub-processes for the portion of FIG. 5 that uses a guest version of sharing rights in accordance with the present invention.

### DETAILED DESCRIPTION OF THE EMBODIMENTS

The embodiments described herein enable seamless mobility of Digital Rights Management (DRM) content stored on various wired or wireless communication devices, such as set-top boxes, mobile stations, and other computing devices having communication capabilities. The method disclosed here provides the mechanism to enable sharing of security protected content among various entities.

Many communication devices may benefit from the secure manner in which control and data may be communicated among devices in accordance with the present invention. Although various types of wired and wireless communication devices exist, of particular interest are wireless communication devices that include wireless communication capabilities and portable power sources. Wireless communication capabilities include, but are not limited to, wireless links that utilized one or more peer-to-peer or ad hoc protocols, such as HomeRF, Bluetooth, IEEE 802.11 (a, b, g, or n), and the like. Wireless communication capabilities further include, but are not limited to, wireless links that utilized one or more communication protocols, such as TDMA (including GSM), CDMA, UMTS, CDMA 2000, IEEE 802.16, and other related protocols. It is also conceivable to apply the concepts herein to other forms of wireless communication such as infrared technology or proprietary RF technology.

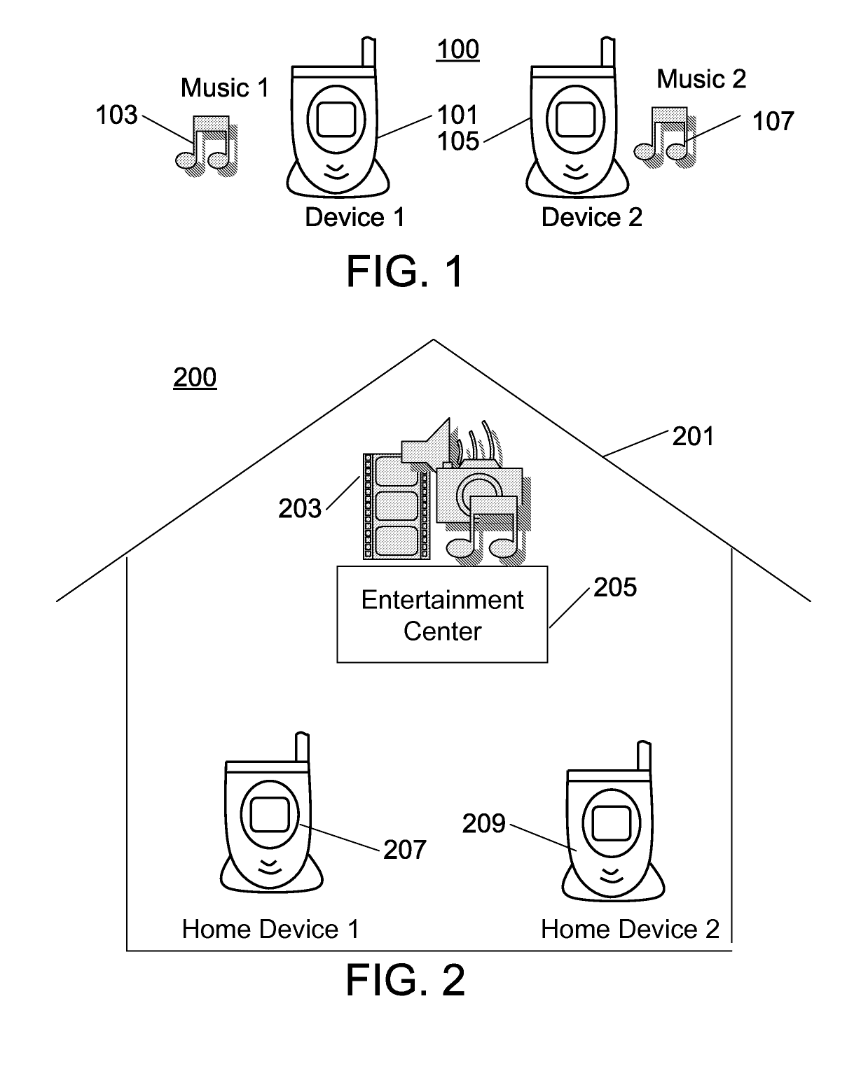

Referring to FIGS. 1, 2 and 3, many use cases may benefit from the system and method for enabling direct sharing between devices, and the figures illustrate same examples. FIG. 1 illustrates an embodiment 100 in which devices may directly share content in accordance with the present invention. For example, two people, each having a device, may meet at a common venue and wish to share rights for one or more selections of content between their devices. A first device 101 belonging to one user may include a first media content 103, and a second device 105 belonging to another user in the same area may include a second media content 107. The first device 101 may provide rights associated with the first media content 103 to the second device 105, and/or the second device 105 may provide rights associated with the second media content 107 to the first device 101. The rights may include requirements, such as allowing for the content to be shared with a finite number of devices.

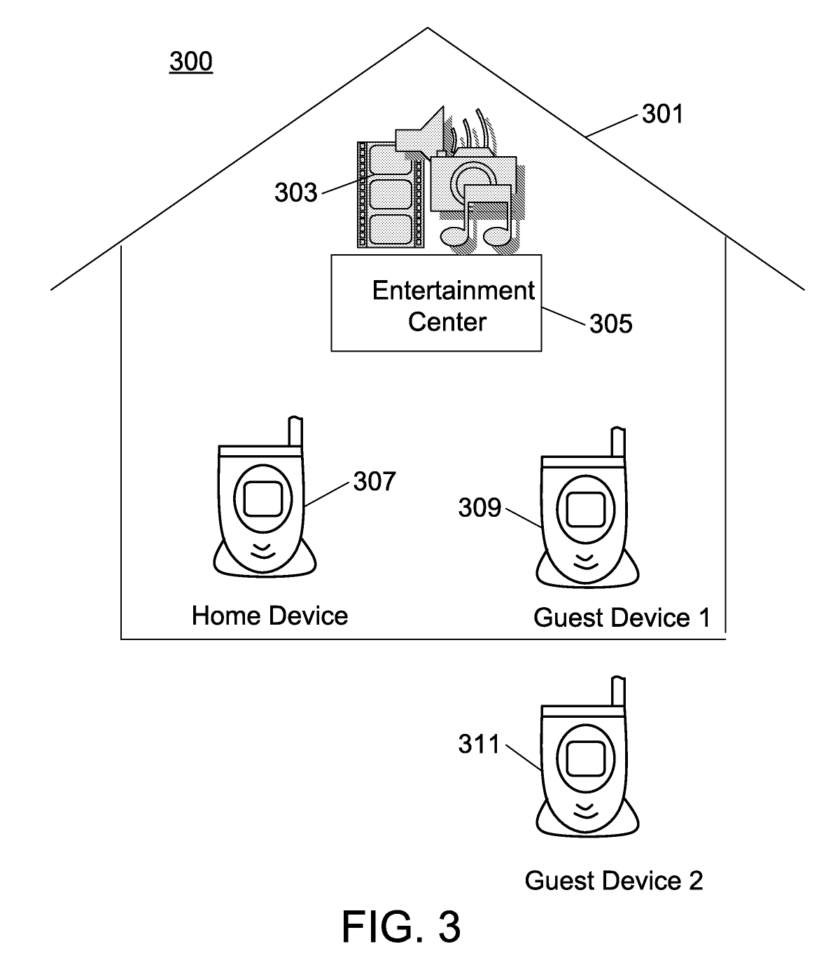

FIG. 2 illustrates an embodiment 200 in which devices belonging to a particular network may share content in accordance with the present invention. A user in a particular venue may have content stored on a media center. For example, in one's home 201, a video content 203 may be stored on component of an entertainment system 205. If the user wants to view the video content 203 on a handheld device 207, 209, then the system may transfer the video content, or a copy thereof, from the component of the entertainment system 205 to a handheld device. The rights for the video content 203 may include requirements, such as dictating that the video content may be shared only among devices that belong to a home network of the home 201 and not with devices that do not belong to the home network.

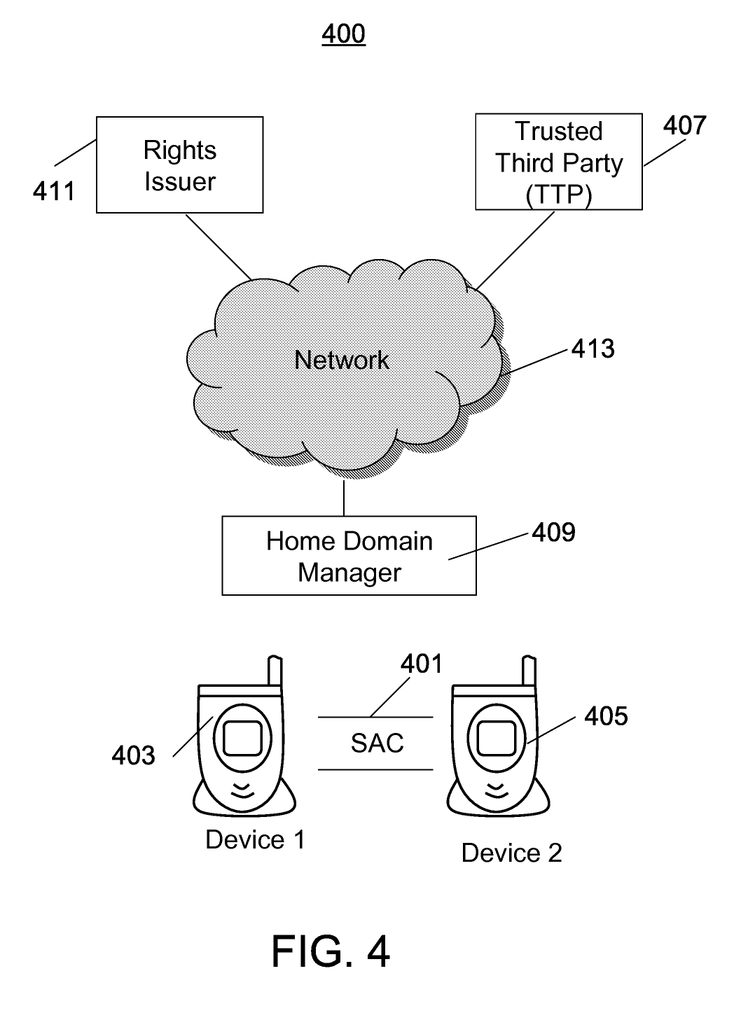

FIG. 3 illustrates an embodiment in which content may be shared, on a limited basis, with a device that does not belong to a particular network in accordance with the present invention. Again, similar to the above embodiment, a user in a particular venue may have content stored on a media center. For example, a user in a home environment 301 may have a video content 303 stored on a component of an entertainment system 305. The user may wish to transfer the video content 303, or a copy thereof, from the component of the entertainment system 305 to a handheld device 307, 309. The rights for the video content 303 may include requirements, such as dictating that the video content 303 may be shared on a permanent basis among devices 307 in a home network of the home environment 301 and on a temporary basis with devices 309, 311 that do not belong to the home network. When a guest visits the user at the user's home environment 301, the guest may be able to transfer or copy the video content 303 from the component of the entertainment system 305 to a handheld device 309 that belongs to the guest, so that the guest may view the video content at the guest's device. When the guest's device 311 leaves the user's home environment 301, the device may no longer provide the video content 303. Alternatively, the rights for the video content 303 may include permissions allowing the guest's device 311 to continue to play the video content for a limited amount of time.

To enable each of these use cases, a new type of a secure authenticated channel (SAC) is established. For the first use case illustrated by FIG. 1, the SAC is established between the two devices 101, 105 of the two users. For the second use case illustrated by FIG. 2, a SAC is established between the user's device 207, 209 and the user's device or component of the entertainment system 205. Another SAC may be established also between the two devices 207, 209. For the third use case illustrated by FIG. 3, a SAC is established between the guest's device 309 and the user's device or component of the entertainment system 305. Also, other SACs may be established between the devices 307, 309, 311. Also, yet other SACs may be established between these devices and the entertainment system 305. Once established between two devices, the same SAC can be used for all future secure sharing of rights and content between the two devices. In other words, once established, the same SAC can be used for all sharing use cases. For example, if the two users in the first use case visit each other at their homes, then the devices of the two users may re-use the same SAC established in the first use case to enable them to share content on a temporary basis as described in the third use case.

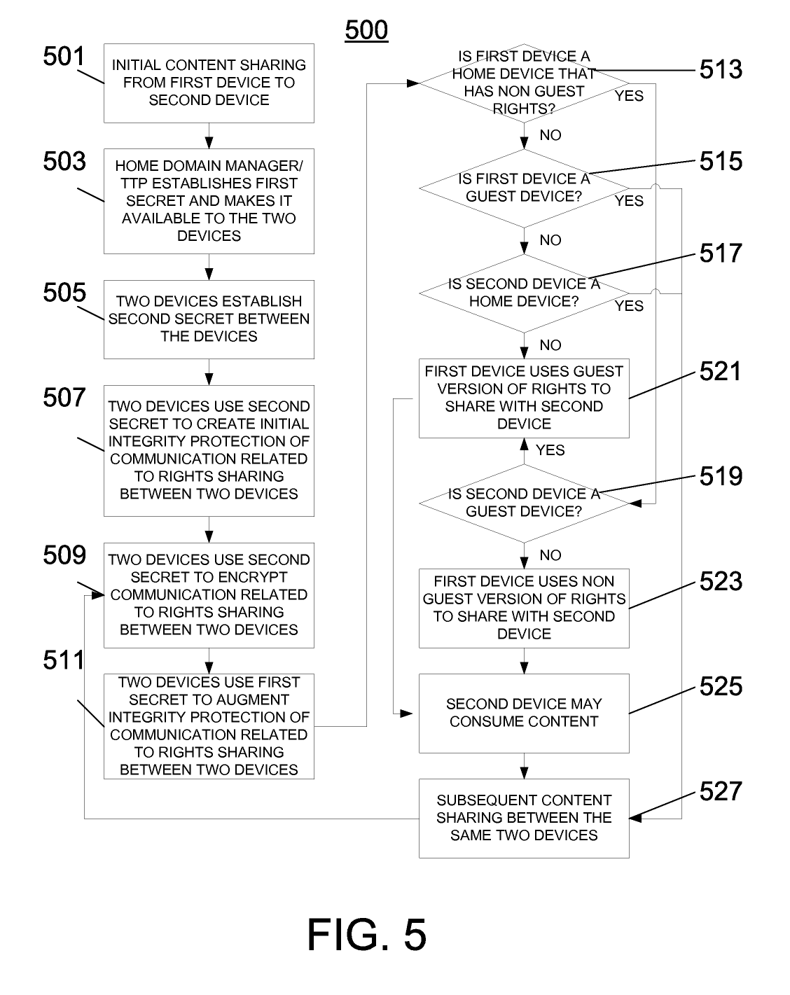

Referring to FIG. 4, the secure authenticated channel (SAC) may be applied as described below. For this embodiment 400, a first SAC 401 may be established directly between two devices 403, 405. For example, the first SAC 401 may be established by re-using the same SAC method used in OMA SRM. This first SAC 401 may be modified so that the cryptographic integrity of the data used in communicating rights between the two devices 403, 405 may become based on a secret key or keys communicated from a trusted-third party (TTP) 407 or a home domain manager 409 to the two devices 403, 405. Such communication of keys may be directly between the TTP 407 or the home domain manager 409 and each of the two devices 403, 405, or via a combination of direct and relayed communications. The keys cryptographically protect the content decryption keys and rights associated with the content. Such decryption keys and rights may be issued by a rights issuer 411 or the home domain manager 409. The decryption keys and rights may be bundled in a Rights Object. The TTP 407, home domain manager 409 and rights issuer 411 may communicate with each other directly or via a wired or wireless network 413.

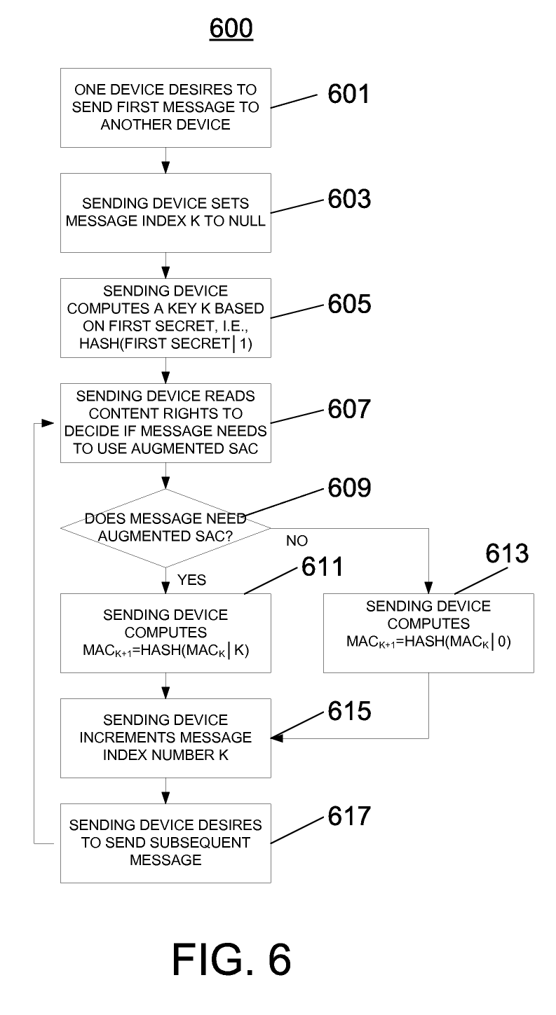

FIG. 5 is a flow diagram illustrating an example process 500 in which devices may directly share content in accordance with the present invention. For the embodiment illustrated, content sharing from one device to another device is initiated at step 501. Each device may be within or associated with a home network. A TTP 407 or home network manager 409 may then assign to the devices, on a temporary or permanent basis, a first shared secret that is common to them, and make the first shared secret available to both devices at step 503. The first shared secret may also, perhaps, be shared to other devices within or associated with that same home network. This first shared secret may be used in conjunction with a second shared secret, independent of the first shared secret, which is established directly between the two devices, as represented by step 505. Either of the two shared secrets may be established before the other. The two devices use the second shared secret to create initial integrity-protection of communication related to rights sharing between the two devices at step 507. The two devices also use the second secret to encrypt communication related to rights sharing between the devices at step 509. Two devices may be concurrently associated with a plurality of home networks or home domains, where a shared secret used in one home domain may be derived independently of a shared secret used in another home domain. The two devices may then use the first secret to augment the integrity protection of communication related to rights sharing between the devices at step 511. Revealing of confidential data that is to go only to domain members follows two-way integrity-protected message exchange, where domain shared secret is used to augment or enhance, rather than replace, direct-SAC based integrity protection mechanism.

Steps 513 through 519 establish the types and rights, such as digital management rights, of the devices attempting direct sharing of content. It is to be understood that the steps of this embodiment are merely examples, and any process for determining the types and/or rights of one or both devices may be utilized. The type and rights of the first device is determined at steps 513 and 515, and the type and rights of the second device is determined at steps 517 and 519. If the first device is not a home device with non-guest rights, and it is not a guest device, then the process 500 proceeds to examine whether the second device is a home device at step 517. If not, then the first device may use a guest version of rights to share with the second device, as represented by step 521. In a different situation, if the first device is a home device with non-guest rights, then the process 500 determines whether the second device is a guest device. If so, then the first device may use a guest version of rights to share with the second device, as represented by step 521. If, on the other hand, the second device is not a guest device, then the first devices may use a non-guest version of rights to share with the second device at step 523. In any of the above situations, the process 500 continues by allowing the second device to consume content at step 525 and permitting subsequent content sharing between these same devices at step 527. Thereafter, the process 500 returns to encrypting communication relating to rights sharing between the devices, using the second secret, at step 509.

If the first device is not a home device with non-guest rights at step 513 but the first is a guest device at step 515 or the second device is a home device at step 517, then the process 500 would bypass steps 521, 523 & 525 and permit subsequent content sharing between the same devices at step 527. Thereafter, the process 500 returns to encrypting communication relating to rights sharing between the devices, using the second secret, at step 509.

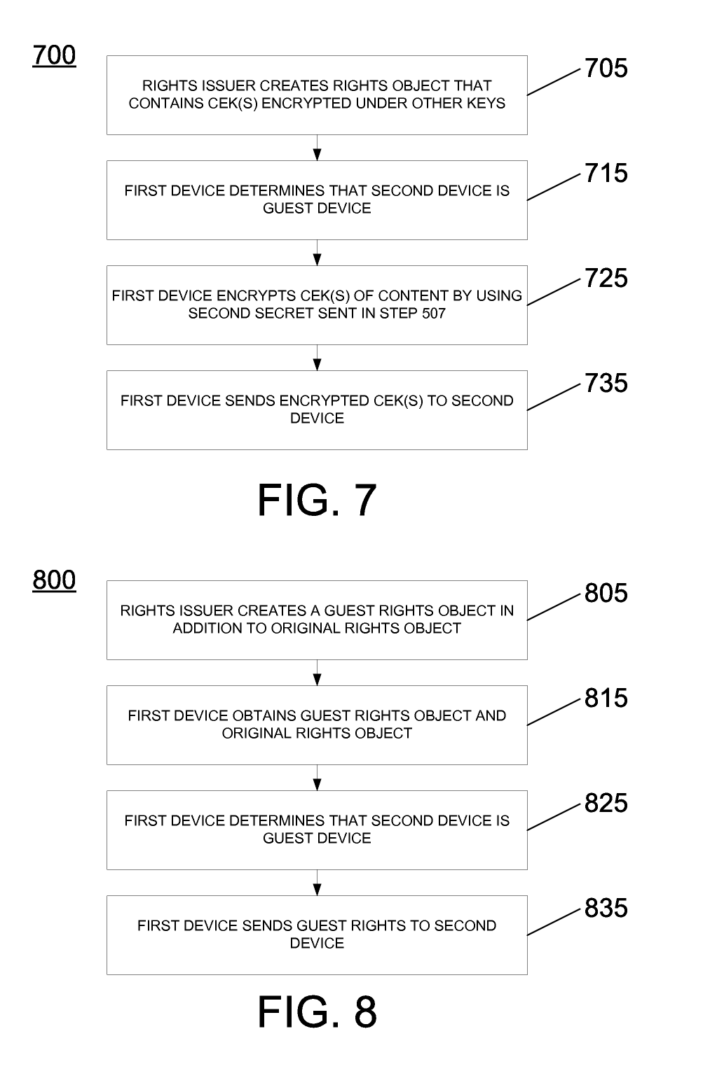

FIG. 6 is a flow diagram illustrating an example sub-process for the portion of FIG. 5 that identifies a home device and/or guest device in accordance with the present. In particular, FIG. 6 provides an embodiment for step 511. For one embodiment, a domain shared secret/key K may be used to enhance the SAC that is set-up directly between the two devices, such as MACₖ₊₁=hash(MACₖ|X), where X=K if MACₖ₊₁ is an enhanced value and X=“0” otherwise. “|” denotes concatenation. Here MACⱼ for any j denotes a key used in a Message Authentication Code algorithm or procedure. HMAC, comprising a keyed-hash message authentication code, is one such algorithm. “hash(x)” denotes the application of a one-way hash function or algorithm to an argument x. SHA-1 is one such hash function. The successive modification of the MAC key is one means to address unauthorized message replay detection.

The sub-process 600 begins at step 601 where one device desires to send a first message to another device. The sending device sets a message index k to a null value, such as zero, at step 603. The sending device also computes a key k based on the first secret (first secret 11), as represented by step 605. The sending device further reads content rights to determine whether the message needs to use the augmented SAC at step 607. If the message needs augmented SAC at step 609, then the sending device computes MACₖ₊₁=hash(MACₖ|k) at step 611. If on the other hand the message does not need augmented SAC, then the sending device computes MACₖ₊₁=hash(MACₖ|0) at step 613. In any case, the sending device increments the message index k at step 615 and, in response to determining that sending of a subsequent message is desired at step 617, the sending devices returns to reading the content rights at step 607 of the sub-process 600.

There are several aspects of this embodiment that should be noted. A home-domain shared secret may be used to restrict activity to devices associated with a particular home domain. Also, by using home-domain shared secret to enhance rather than define message integrity, non-involved members of home-domain may not effectively spoof communications. Further, by using directly shared secret to encrypt communications that require confidentiality, non-involved members of home-domain may not read sensitive communications and the home domain manager itself may not read such sensitive communications. In addition, by using home-domain shared secret to enhance certain device-to-device communications, only a device with knowledge of home-domain shared secret may successfully send such communications. Still further, in order to address sharing on a guest (e.g., temporary) basis, it is advantageous if an entity may issue rights for content in such a way that access to rights can be securely distinguished as being a certain one of two types.

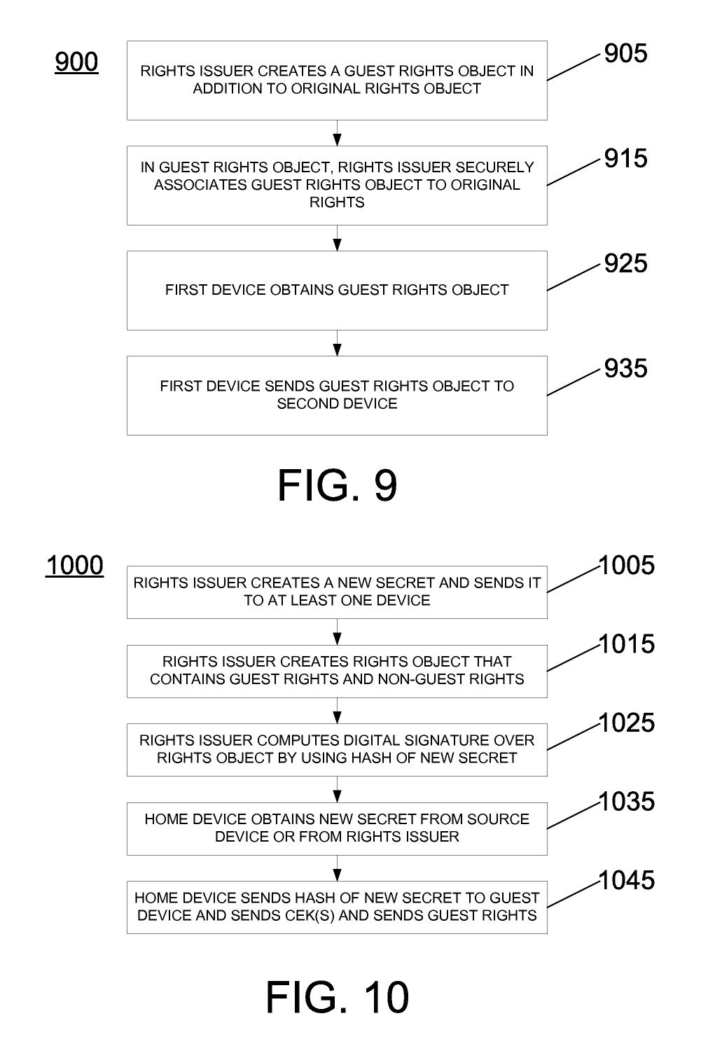

FIGS. 7 through 10 are flow diagrams illustrating example sub-processes for the portion of FIG. 5 that uses a guest version of sharing rights in accordance with the present invention. In one embodiment, represented by FIG. 7, a non-guest rights object (RO) can be ‘converted’ into a guest RO by withholding certain information when conducting a secure transfer or sharing of rights between devices that is intended to convey only guest rights privileges to the sink device. The non-guest RO may be a ‘standard’ RO which may have been generated prior to incorporation of the guest rights vs. non-guest rights feature. As one instantiation, the one or more Content Encryption Keys (CEK) used to decrypt encrypted content associated with an RO can be securely transmitted directly rather than transmitting a Rights Object Encryption Key (REK) or Key-Encrypting Key (KEK) that is applied to a portion of the Rights Object data to recover the CEK(s). In a secure implementation, it is computationally infeasible to derive REK (or KEK) from CEK(s). A rogue or compromised device that has not received non-guest privileges and thus does not know the actual REK or KEK value is prevented from successfully choosing an REK or KEK in order to act as a source device of non-guest rights to another device. This is because, using known-art techniques, the encryption or wrapping of the CEK(s) under the legitimate REK or KEK is independently verifiable as originating with the rights issuer. For example, AES-WRAP (which has a built-in integrity check mechanism) is used to wrap the CEK(s) under REK, where the result is included as one of the arguments over which the rights issuer computes a digital signature. Using [KMMOT], this digital signature is available for verification by each sink device.

Referring to FIG. 7, the rights issuer creates a rights object that contains one or more CEK's that are encrypted under other keys, such as REK or KEK, at step 705. The first device then determines that the second device is a guest device at step 715. The first device also encrypts at step 725 the CEK or CEK's of the content by using the second secret created by the two devices at step 505. The first device further sends the encrypted CEK or CEK's to the second device at step 735.

Referring to FIG. 8, in another embodiment, rights issuers that issue rights for content create two digitally signed Rights Objects (ROs), i.e. matched guest RO and non-guest RO, where the guest RO may explicitly reference the non-guest RO, e.g., via the non-guest RO identifier, but not necessarily vice-versa. The guest RO identifier may even be unknown at the time of generation of the non-guest RO. It is computationally infeasible for devices or other non-rights issuer entities to derive non-guest ROs from guest ROs, or to make successful non-guest use of non-guest ROs unless granted non-guest privileges. This can be accomplished by extending the structure of the above embodiment to include an explicit guest RO. In this case, a guest RO includes the conditions of guest usage and other essential criteria that the rights issuer wishes to relay. The guest RO may, in particular, include hash values computed over one or more of the CEKs that can be used to verify CEK validity once given the CEK(s).

As shown by the embodiment of FIG. 8, the rights issuer creates a guest rights object in addition to the original rights object at step 805. The first device then obtains the guest rights object and the original rights object at step 815. Next, the first device determines that the second device is a guest device at step 825. Thereafter, the first device sends guest rights to the second device at step 835.

Referring to FIG. 9, a rights issuer digital signature can be used to ensure source and data integrity of the guest RO. In particular, if a rights issuers wants to charge for acquisition of a guest RO that is cryptographically associated to a non-guest RO (as part of initial acquisition or as an upgrading operation), the rights issuer digital signature prevents counterfeiting of guest RO's. If as a condition of acceptance of a guest RO by a compliant device it must be accompanied by a matched non-guest RO (verifiable, e.g., via the non-guest RO identifier), then a guest RO cannot be reused successfully with a non-matching non-guest RO even if the non-matching non-guest RO is associated with the same content and CEK(s) as a matching non-guest RO.

As shown by the embodiment of FIG. 9, the rights issuer creates a guest rights object in addition the original rights object at step 905. In the guest rights object, the rights issuer then securely associates the guest rights object to the original rights at step 915. Next, the first device obtains the guest rights object at step 925. The first device also sends the guest rights object to the second device at step 935.

Referring to FIG. 10, an alternative embodiment makes use of a secret S that is implicitly or explicitly shared between the rights issuer and the device to which the RO is initially cryptographically bound or between the rights issuer and a set of devices to which the RO is initially cryptographically bound, where membership in the set of devices may vary over time. The value hash(S) is included as one of the arguments in the RO over which the rights issuer digital signature is computed. The value of “S” is securely released between devices only when a device intends to convey non-guest privileges to another device.

As shown by the embodiment of FIG. 10, the rights issuer creates a new secret and sends it to one or more devices at step 1005. The rights issuer also creates a rights object that contains guest rights and non-guest rights at step 1015. The rights issuer then computes a digital signature over the rights object by using a hash of the new secret at step 1025. Next, the home device obtains the new secret from the source device or from the rights issuer at step 1035. Thereafter, the home device sends the hash of the new secret to the guest device and sends CEK(s) and sends guest rights at step 1045.

In one usage scenario in Step 515 of FIG. 5, “guest” devices only receive (i.e., do not transmit) access to rights, and only to ‘temporary’ rights (e.g., rights associated with ROs marked as conveying (solely) ‘temporary’ rights). Guest-only access is legitimately transferred only to guest devices (e.g., via ROs marked as conveying temporary rights and unaccompanied by ROs with matched non-temporary rights), (see steps 513, 515 & 517 of FIG. 5). Home domain managers can impose certain criteria as prerequisites for resident/non-guest membership, which can also serve to limit the number of domain managers a given device can be associated with as a resident member. Domain managers can limit the number of guest devices they allow, e.g., on a per time-period basis. Guest rights are not necessarily temporary, and it is given as an example attribute. The use of guest rights aids in the control of unintended sharing or dissemination of rights even by unknown-compromised devices. Compliant devices currently acting in a sink role detect abuse by devices currently acting in a source role.

It should be further noted that the above description does not restrict the definition of a home device and a guest device. For example, it is possible that all devices belong to a home network, but that the rights for content are limited so that full rights are limited to a small number of devices, say on a first-come first-serve basis. In this case, once the limited number is reached, additional devices may be allowed to consume content on a restricted basis. This would mean that the additional devices would be treated as “guest” devices.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method for a communication device for establishing a secure authenticated channel using multiple shared keys traded with another device, the method comprising:
receiving a first shared key common to the communication device and the other device from a remote device;
establishing a second shared key with the other device;
creating initial integrity protection of communication relating to rights sharing between the communication device and the other device using the second shared key; and
augmenting the integrity protection of communication relating to rights sharing between the communication device and the other device using the first shared key.

2. The method of claim 1, further comprising initiating content sharing from the communication device to the other device before establishing a second shared key with the other device.

3. The method of claim 1, wherein receiving a first shared key common to the communication device and the other device includes receiving the first shared key from a home domain manager.

4. The method of claim 1, wherein receiving a first shared key common to the communication device and the other device includes receiving the first shared key from a trusted third party.

5. The method of claim 1, further comprising encrypting the communication relating to rights sharing between the communication device and the other device using the second shared key.

6. The method of claim 1, further comprising determining a device type and/or a device rights of at least one device.

7. The method of claim 6, further comprising using a guest version of rights to share with the other device based on the device type and/or the device rights.

8. The method of claim 6, further comprising using a non-guest version of rights to share with the other device based on the device type and/or the device rights.

9. The method of claim 6, further comprising permitting subsequent content sharing between the communication device and the other device based on the device type and/or device rights.

10. The method of claim 1, wherein non-involved members of the home domain and the home domain manager are unable to read the encrypted communication.

11. The method of claim 1, wherein receiving a first shared key common to the communication device and the other device includes sharing the first shared key with at least one additional device associated with a home domain.

12. The method of claim 1, wherein receiving a first shared key common to the communication device and the other device includes failing to share the first shared key from at least one additional device associated with a home domain.
